(19) United States
(12) Patent Application Publication
(10) Pub. No.: US 2013/0033141 A1
(43) Pub. Date: Feb. 7, 2013

(54) Magnetic Rotary Power Source

(71) Applicant: Wen-Tang Yan, Taichung (TW)

(72) Inventor: Wen-Tang Yan, Taichung (TW)

(21) Appl. No.: 13/195,017

(22) Filed: Aug. 1, 2011

(51) Int. Cl. H02K 21/00; H02N 11/00

(52) U.S. Cl. 310/152; 74/DIG. 9

(57) ABSTRACT

A magnetic rotary power source which can provide rotary power without energy consumption is disclosed. The power source includes a housing with two parallel spindles. Each spindle is disposed with a gear. The two gears have the same diameter and engage with each other. Each gear is disposed with a permanent magnet. The two magnets are arranged in a specific angular relation, and outer ends of the magnets are the same pole to generate repulsion. When one of the gears is rotated to make the magnets approach, the two gears will automatically rotate by the repulsion between the magnets. The two gears will continuously rotate when they rotate one revolution to make the magnets approach again. Thus, the gears can go round and round repeatedly.

### BACKGROUND OF THE INVENTION

1. Technical Field

The invention relates to rotary power sources, particularly to power sources without energy consumption.

2. Related Art

With the consciousness-raising of environment protection, innovations and developments in various green energy technologies have been constantly making. Many products with low energy-consumption or without energy-consumption appear in the markets. Green energy, as known as renewable energy, is energy which comes from natural resources such as sunlight, wind, rain, tides, and geothermal heat, which are renewable (naturally replenished). Magnetic force, however, has not effectively applied as energy even if it is zero carbon emission.

Rotary power sources, such as motors and engines, are generally applied in many fields. Motors and engines must consume electricity and fuel, respectively. In other words, they output mechanical energy by consuming resources. No rotary power source without energy consumption appears in the world except wind power motors. Wind power motors, however, must depend upon unstable wind. Their rotation speed is hard to be controlled and they cannot be used indoors. Thus wind power motors are so limited in application.

### SUMMARY OF THE INVENTION

An object of the invention is to provide a magnetic rotary power source, which can provide continuous and stable rotary power without consuming any energy. The invention may serve as a motor or generator.

To accomplish the above object, the invention includes a housing with two parallel spindles. Each spindle is disposed with a gear. The two gears have the same diameter and engage with each other. Each gear is disposed with a permanent magnet. The two magnets are arranged in a specific angular relationship, and outer ends of the magnets are the same pole to generate repulsion. When one of the gears is rotated to make the magnets approach, the two gears will automatically rotate by the repulsion between the magnets. The two gears will continuously rotate when they rotate one revolution to make the magnets approach again. Thus, the gears can go round and round repeatedly.

### BRIEF DESCRIPTION OF THE DRAWINGS

FIG. 1 is a cross-sectional view of the first embodiment of the invention;

FIG. 2 illustrates positional relation of the two gears of the first embodiment shown in FIG. 1;

FIG. 3 is a cross-sectional view of the second embodiment of the invention; and

FIG. 4 is top view of the third embodiment of the invention.

### DETAILED DESCRIPTION OF THE INVENTION

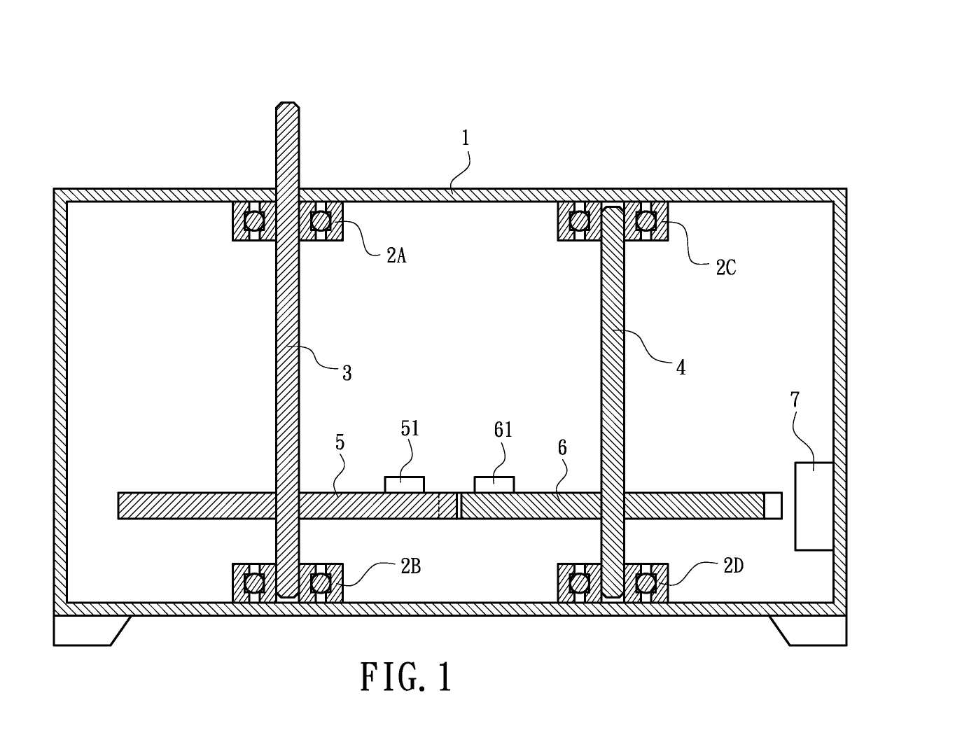

Please refer to FIG. 1. The rotary power source of the invention arranges a first spindle 3 and a second spindle 4 in a housing 1. The two spindles 3, 4 are parallelly and rotatably fixed on two opposite sides of the housing by bearings 2A, 2B, 2C, 2D. The bearings 2A, 2B, 2C, 2D may be ball bearings or any other types with low rolling friction. The first spindle 3 protrudes from the housing 1 to serve as an output shaft of rotary power.

The first spindle 3 and second spindle 4 are disposed with a first gear 5 and a second gear 6, respectively. The two gears 5, 6 are completely identical in diameter and engage with each other so as to be capable of rotating in the same angular velocity and linear velocity. A first permanent magnet 51 and a second permanent magnet 61 are fixed on the first gear 5 and second gear 6, respectively. Locations of the two permanent magnets 51, 61 on the gears 5, 6 are arranged in a specific angular relation. Outer magnetic poles of the two permanent magnets 51, 61 are identical in polarity, i.e. they both are the same N pole or S pole to form repulsion. Additionally, a starter 7 is arranged beside the second gear 6. The starter 7 may be hand-operated or motor-driven for driving the second gear 6 to initially rotate. The starter 7 has a clutch as well to release the engagement with the second gear 6 after the gears 5, 6 have been rotating independently. Of course, the starter 7 may be alternatively disposed beside the first gear 5 to start with it.

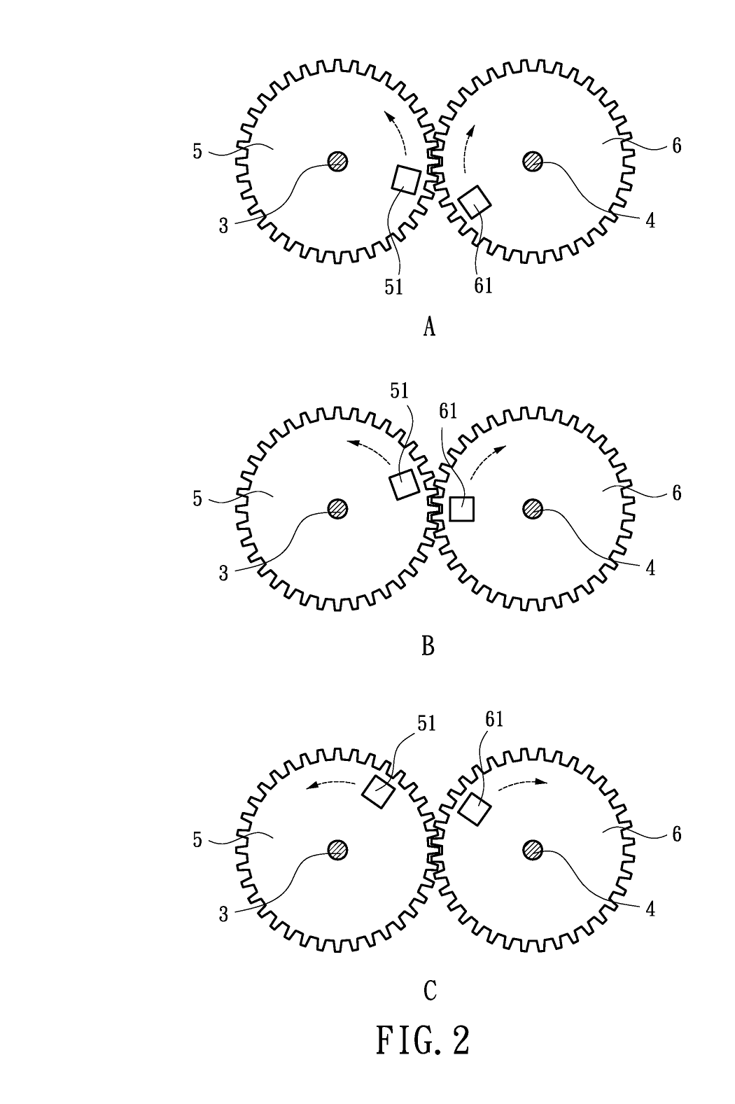

Please refer to FIG. 2, which shows the relative relation of the permanent magnets 51, 61 rotated with the gears 5, 6. The arrangement of the permanent magnets 51, 61, as shown in FIG. 2A, is that the first permanent magnet 51 reaches the engagement point of the two gears 5, 6 slightly earlier than the second magnet 61. The angular difference between the two permanent magnets reaching the engagement point is about 5 to 15 degrees. When the second gear 4 is rotated by the starter 7 to the position as shown in FIG. 2A, repulsion between the permanent magnets 51, 61 occurs so that the first gear 5 is pushed by the repulsion to rotate counterclockwise and the first gear 5 also rotates the second gear 6 clockwise as shown in FIGS. 2B and 2C. In the status of FIG. 2C, the repulsion between the permanent magnets 51, 61 disappears because of a far distance, but the gears 5, 6 will continuously rotate by inertia and low friction of the bearings 2A-2D. Until the gears 5, 6 rotate to the position shown in FIG. 2A, they can be rotated by the repulsion again. As a result, the gears 5, 6 go round and round repeatedly. The permanent magnets 51, 61 will always keep a constant positional relation because of the same diameter and geared engagement. This can keep the gears rotating constantly.

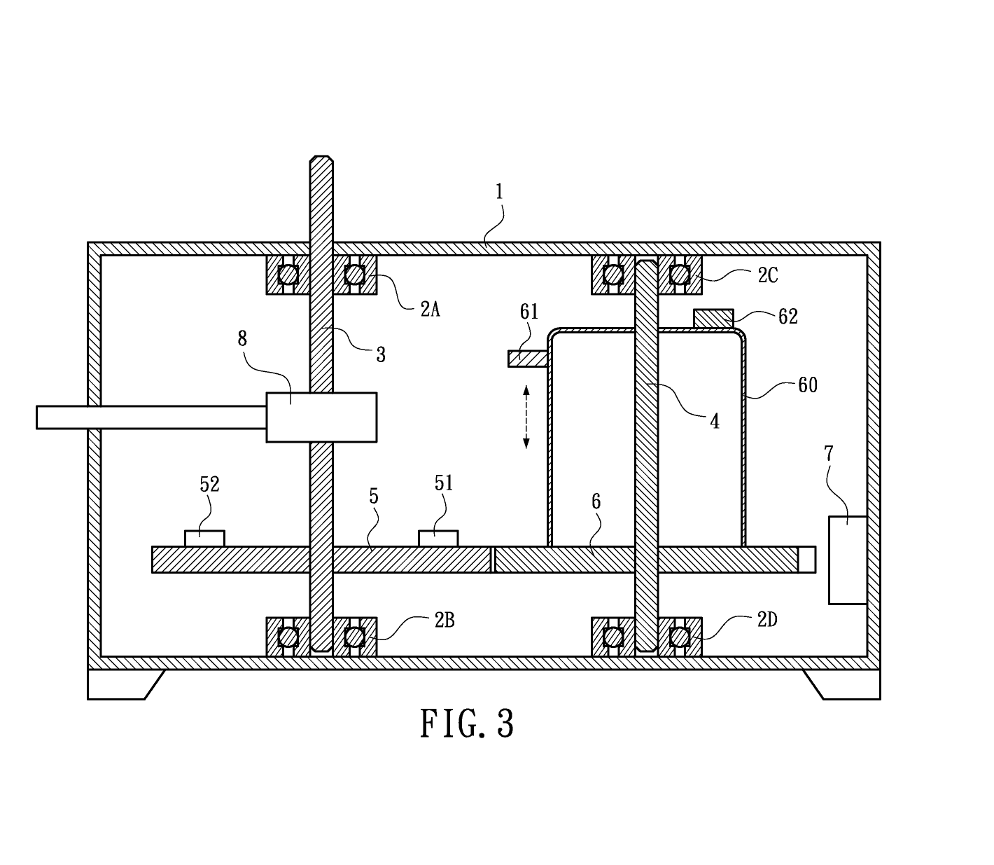

Please refer to FIG. 3, which shows the second embodiment of the invention. In this embodiment, the second gear 6 is additionally disposed with a frame 60 which is formed into a cross or inverted-cup shape. The second permanent magnet 61 is movably fixed on the frame 60 so that the height position of the second permanent magnet 61 is adjustable. Strength of the repulsion between the permanent magnets 51, 61 and rotation speed of the gears 5, 6 may be adjusted by the adjustment of second permanent magnet 61. When the permanent magnets 51, 61 are heavy in weight, weighted blocks 52, 62 may be further mounted on the gears 5, 6 for balance and increasing moment of inertia. Additionally, a break 8 may be arranged for stopping rotation of the gears 5, 6.

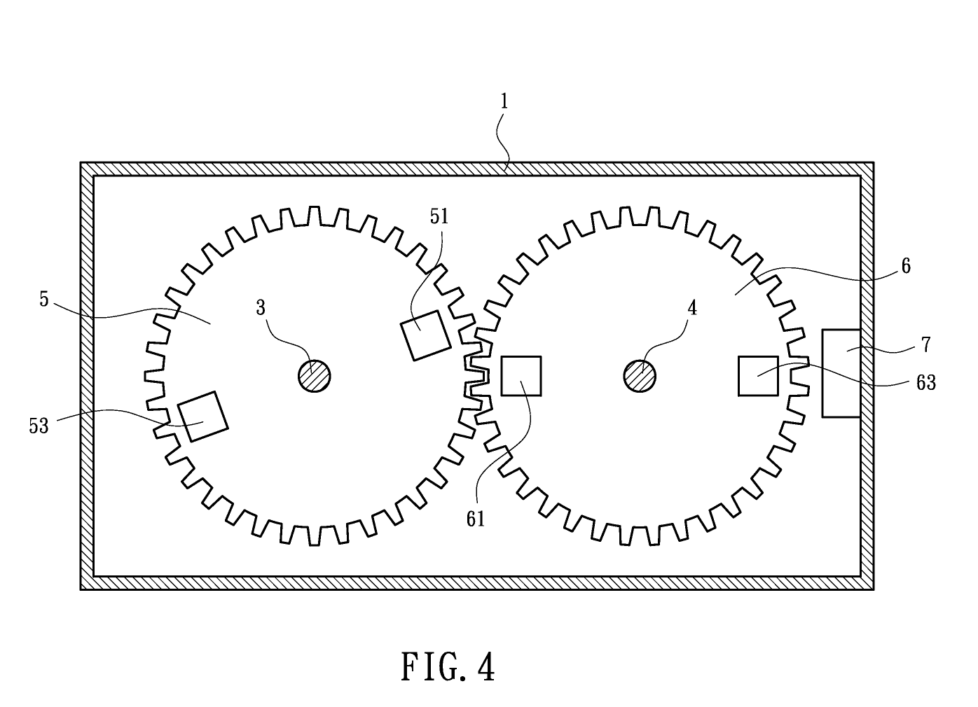

Besides, for more stable rotation of the gears 5, 6, the number of the permanent magnets 51, 61 may be added. The third embodiment of the invention as shown in FIG. 4 disposes two permanent magnets 51, 53; 61, 63 on each gear 5, 6 in a radial arrangement, i.e. 180 degrees. Such an arrangement will make the gears 5, 6 rotated by repulsion per 180 degrees.

As abovementioned, the invention operates by magnetic force without energy consumption. It can be used as a motor. For example, the invention can be connected with a generator, fan, embellishment, etc.

While the forgoing is directed to preferred embodiments of the present invention, other and further embodiments of the invention may be devised without departing from the basic scope thereof. As such, the appropriate scope of the invention is to be determined according to the claims.

What is claimed is:

1. A magnetic rotary power source comprising:
a housing;
two spindles, parallelly disposed in the housing;
two gears, separately disposed on the two spindles, wherein diameters of the two gears are identical, and the gears engage with each other; and
two permanent magnets, separately fixed on the two gears, wherein locations of the two permanent magnets on the gears are arranged in a specific angular relation, and outer magnetic poles of the two permanent magnets are identical in polarity.

2. The magnetic rotary power source of claim 1, further comprising a starter disposed beside one of the two gears for driving the gear to initially rotate.

3. The magnetic rotary power source of claim 2, further comprising a clutch in the starter for releasing engagement between the gear and the starter.

4. The magnetic rotary power source of claim 1, wherein one of the permanent magnets is earlier to reach an engagement point of the two gears than the other.

5. The magnetic rotary power source of claim 4, wherein an angular difference between the two permanent magnets reaching the engagement point is about 5 to 15 degrees.

6. The magnetic rotary power source of claim 1, wherein each of the spindles is rotatably fixed on two opposite sides of the housing by two bearings.

7. The magnetic rotary power source of claim 1, wherein at least one of the spindles protrudes from the housing.

8. The magnetic rotary power source of claim 1, wherein one of the gears is disposed with a frame for adjustably fixing the permanent magnet.

9. The magnetic rotary power source of claim 8, further comprising a weighted block on the frame for balance.

10. The magnetic rotary power source of claim 1, wherein each of the gears is disposed with a weighted block.

11. The magnetic rotary power source of claim 1, further comprising a brake disposed beside one of the gears or the spindles.
